(19) United States
(12) Patent Application Publication
(10) Pub. No.: US 2019/0006851 A1
(43) Pub. Date: Jan. 3, 2019

(54) SPLIT-TYPE POWER OPTIMIZATION MODULE FOR SOLAR MODULE STRINGS OF A SOLAR PANEL

(71) Applicant: BEIJING SINBON TONGAN ELECTRONICS CO., LTD., Beijing (CN)

(72) Inventors: Jing-Jun GU, Beijing (CN); Zhi WANG, Beijing (CN); Xue-Feng ZHANG, Beijing (CN); Jian-Bin TONG, Beijing (CN)

(73) Assignee: BEIJING SINBON TONGAN ELECTRONICS CO., LTD., Beijing (CN)

(21) Appl. No.: 15/702,273

(22) Filed: Sep. 12, 2017

(30) Foreign Application Priority Data
Jul. 3, 2017 (CN) 201710532373.7

(51) Int. Cl. H02J 3/38; H02S 40/30; H02S 40/36

(52) U.S. Cl. CPC H02J 3/385; H02S 40/36; H02S 40/30

(57) ABSTRACT

A split-type power optimization module for solar module strings of a solar panel includes multiple power optimization module blocks. Each power optimization module block uniquely corresponds to one of multiple solar module strings on a solar panel and has a single-chip processor, a string connection port, and a power output port. The string connection port is connected to the single-chip processor and an adjacent solar module string. The power output port is connected in series to the power output port of an adjacent power optimization module block. Accordingly, each power optimization module block performs maximum power point tracking for the connected solar module string to lower the power loss of each solar module string and ensure string-level maximum power optimization.

### BACKGROUND OF THE INVENTION

### 1. Field of the Invention

The present invention relates to a solar cell power optimization device, and, more particularly, to a split-type power optimization module for solar module strings of a solar panel capable of performing maximum power point tracking (MPPT) on the basis of individual solar string and providing a fail-safe bypass function.

### 2. Description of the Related Art

The power transmission efficiency of solar panels depends on solar radiation and is also involved with the electrical characteristics under load. When solar radiation on solar panels varies, the load curves for providing maximum power transmission efficiency are also changed. If the loads can be adjusted according to the load curves associated with maximum power transmission efficiency, optimized efficiency of the solar energy system can be secured. The load characteristics associated with the maximum power transmission efficiency pertain to a maximum power point. The so-called MPPT is a process that finds the maximum power point to keep the load characteristics to stay at the point and is related to a power optimization process.

Conventional solar panels with power optimization features do not occupy a large market share and those conventional solar panels in the market basically perform their power optimization based on the entire photovoltaic modules. As each solar panel typically includes three strings of photovoltaic modules, the three strings of photovoltaic modules may be subject to different solar radiations as shaded by tree leaves, buildings and the like of different forms. Under the circumstance, panel-level power efficiency optimization can be carried out while string-level power efficiency optimization may be ignored. In other words, conventional solar panels may not perform the maximum power efficiency optimization and the optimized efficacy of the solar panels from the perspective of the level of the solar strings.

### SUMMARY OF THE INVENTION

An objective of the present invention is to provide a split-type power optimization module for solar module strings of a solar panel targeting at string-based power optimization for a solar panel as a solution tackling the issue of panel-based power optimization in conventional solar panels that fails to achieve maximum power optimization and optimized efficacy.

To achieve the foregoing objective, the split-type power optimization module for solar module strings of a solar panel includes multiple power optimization module blocks and the solar panel includes multiple solar module strings; each power optimization module block includes a string connection port, a power output port, a single-chip processor and a bypass switch.

The string connection port is connected to a power output terminal of a corresponding solar module string of the solar panel.

The power output port has a positive output terminal and a negative output terminal and is connected in series to the power output port of another power optimization module block adjacent to the power optimization module block.

The single-chip processor is connected to the string connection port and the power output port and performs maximum power point tracking (MPPT) on the corresponding solar module string.

The bypass switch is connected between the positive output terminal and the negative output terminal of the power output port.

According to the foregoing description, each power optimization module block performs MPPT on a corresponding solar module string on a one-to-one basis. Therefore, string-based maximum power optimization and optimized efficacy of the entire solar panel can be achieved.

Other objectives, advantages and novel features of the invention will become more apparent from the following detailed description when taken in conjunction with the accompanying drawings.

### BRIEF DESCRIPTION OF THE DRAWINGS

FIG. 1 is a schematic plane view of a split-type power optimization module for solar module strings of a solar panel in accordance with the present invention applicable to a solar panel;

FIGS. 2A to 2D are enlarged plane views of the solar panel in FIG. 1;

FIGS. 3A to 3C are divided circuit diagrams of a first power optimization module used in the solar panel in FIG. 1;

FIGS. 4A to 4C are divided circuit diagrams of a second power optimization module used in the solar panel in FIG. 1;

FIGS. 5A to 5C are divided circuit diagrams of a third power optimization module used in the solar panel in FIG. 1; and

FIG. 6 is a functional block diagram of a single-chip processor built in the power optimization module in FIGS. 3A to 3C, 4A to 4C, and 5A to 5C.

### DETAILED DESCRIPTION OF THE INVENTION

The present invention primarily presents a split-type power optimization module for solar module strings of a solar panel, which includes multiple power optimization module blocks. Each power optimization module block uniquely corresponds to a solar module string on a solar panel.

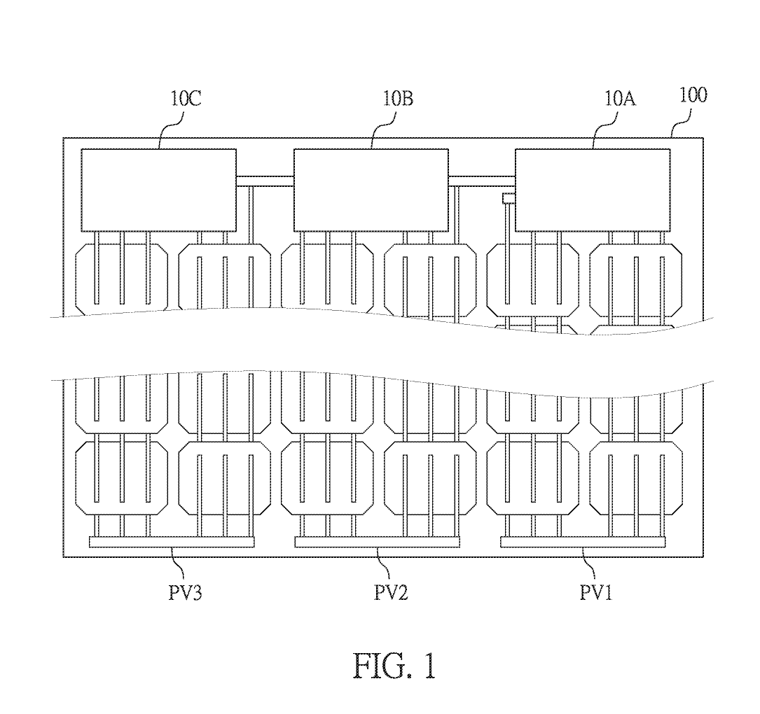

With reference to FIG. 1, a split-type power optimization module for solar module strings of a solar panel in accordance with the present invention includes three power optimization module blocks 10A, 10B, 10C. Each power optimization module block 10A, 10B, 10C is connected to one of three strings of photovoltaic modules PV1, PV2, PV3 on a solar panel 100.

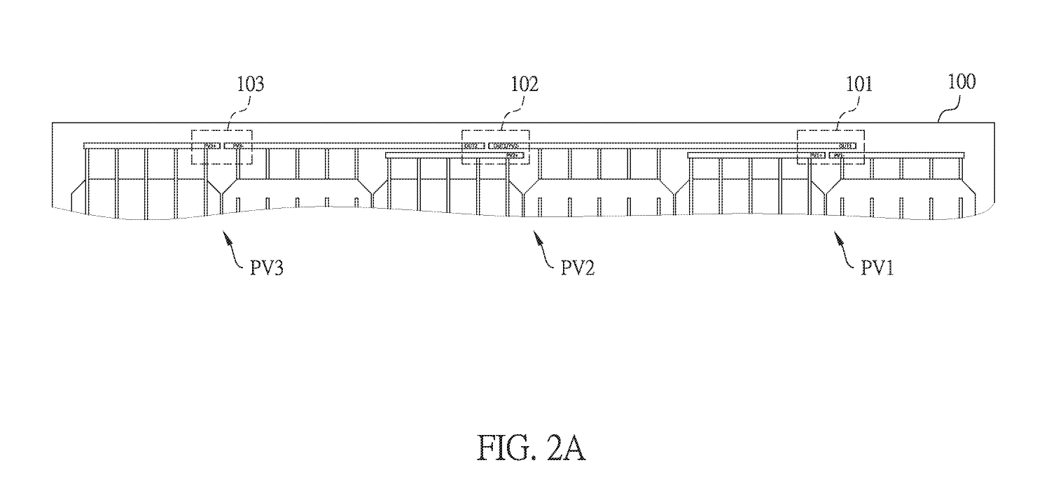

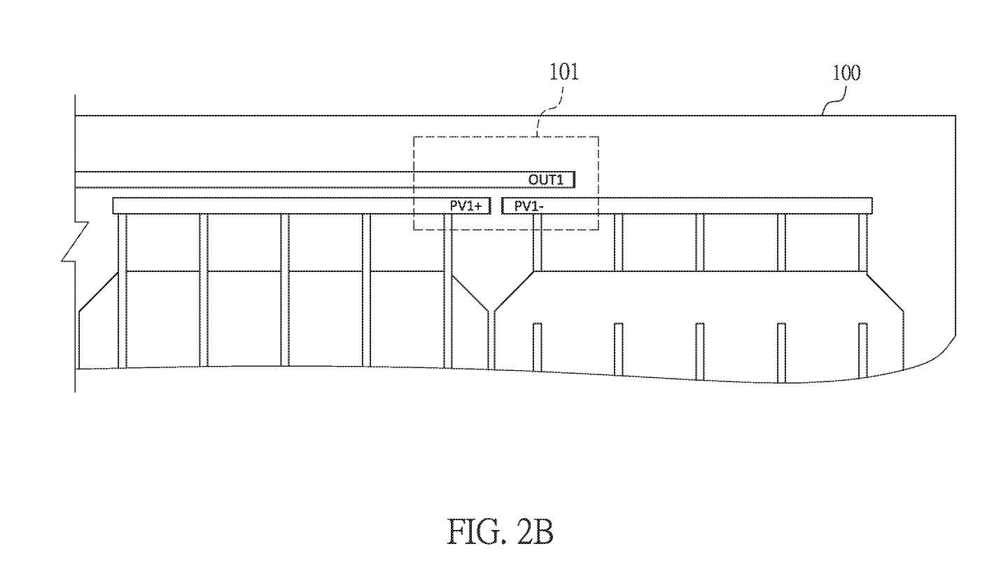

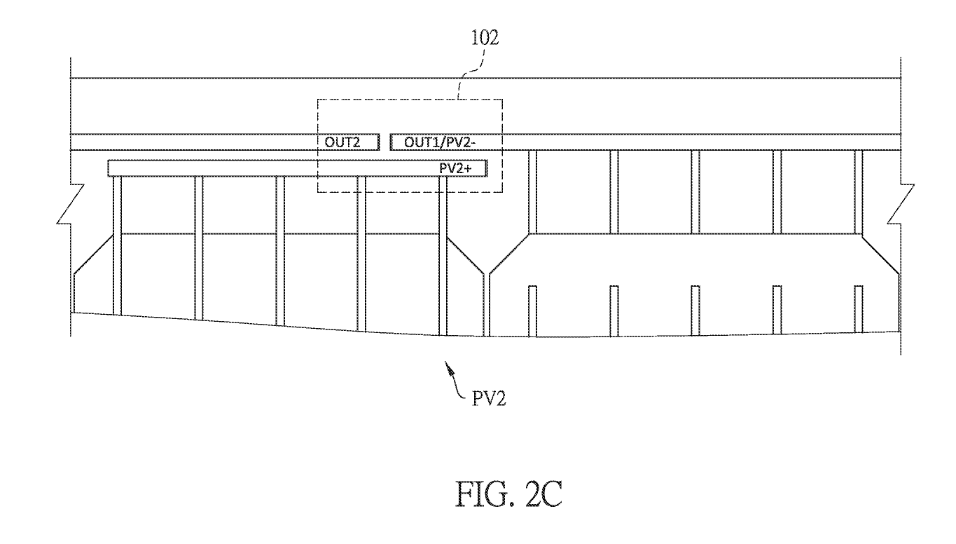

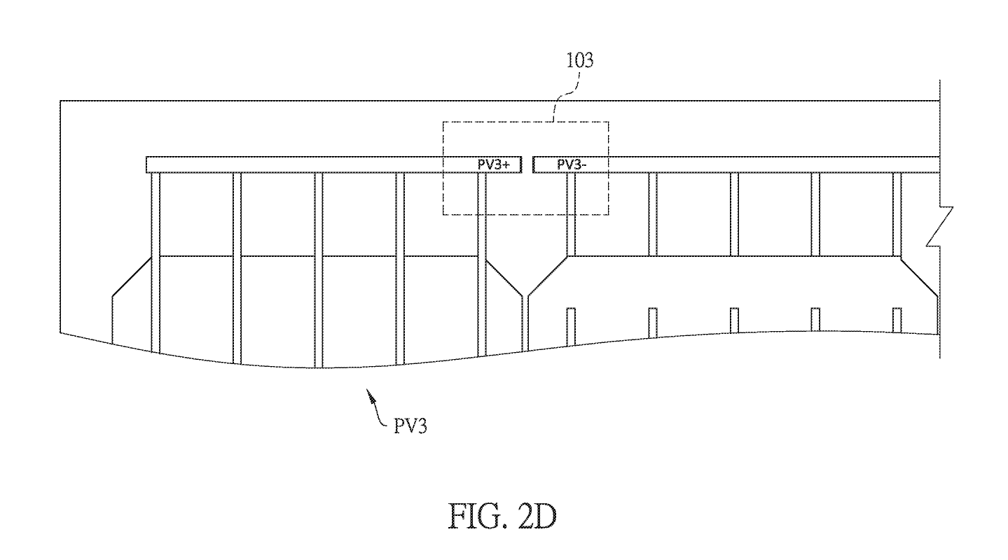

With reference to FIGS. 2A to 2D, each string of photovoltaic modules PV1, PV2, PV3 on the solar panel 100 has a power output terminal 101, 102, 103. The power output terminal 101 of the string of photovoltaic modules PV1 has a positive terminal PV1+ and a negative terminal PV1−, the power output terminal 102 of the string of photovoltaic modules PV2 has a positive terminal PV2+ and a negative terminal PV2−, and the power output terminal 103 of the string of photovoltaic modules PV3 has a positive terminal PV3+ and a negative terminal PV3−. The power output terminals 101, 102, 103 are connected in series through the power optimization module blocks 10A, 10B, 10C. Each power optimization module block 10A, 10B, 10C performs power optimization on a corresponding string of photovoltaic modules PV1, PV2, PV3.

The power optimization module blocks 10A, 10B, 10C are connected to the power output terminals of the respective string of photovoltaic modules PV1, PV2, PV3 to constitute a serial loop.

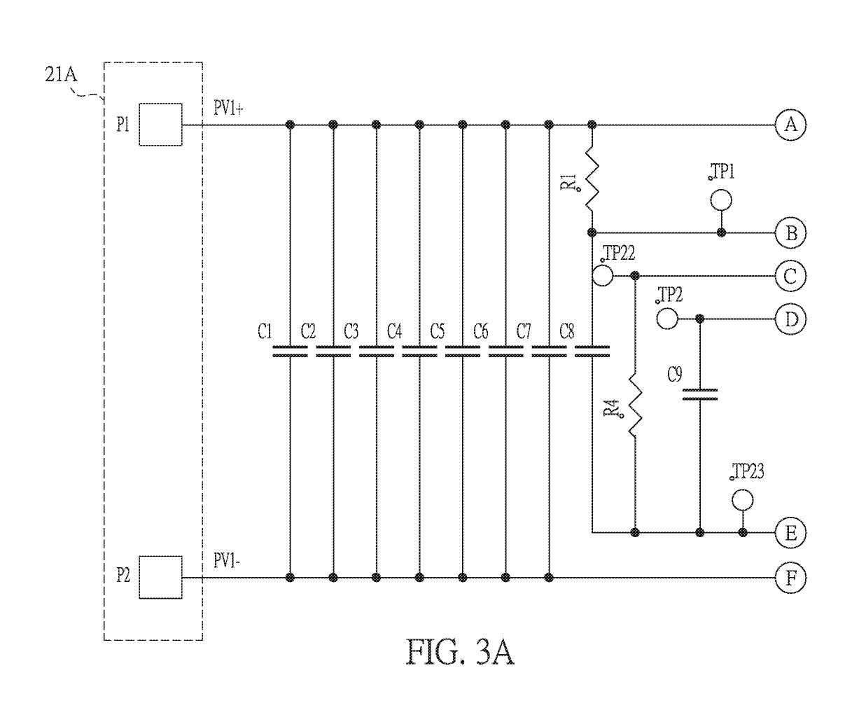

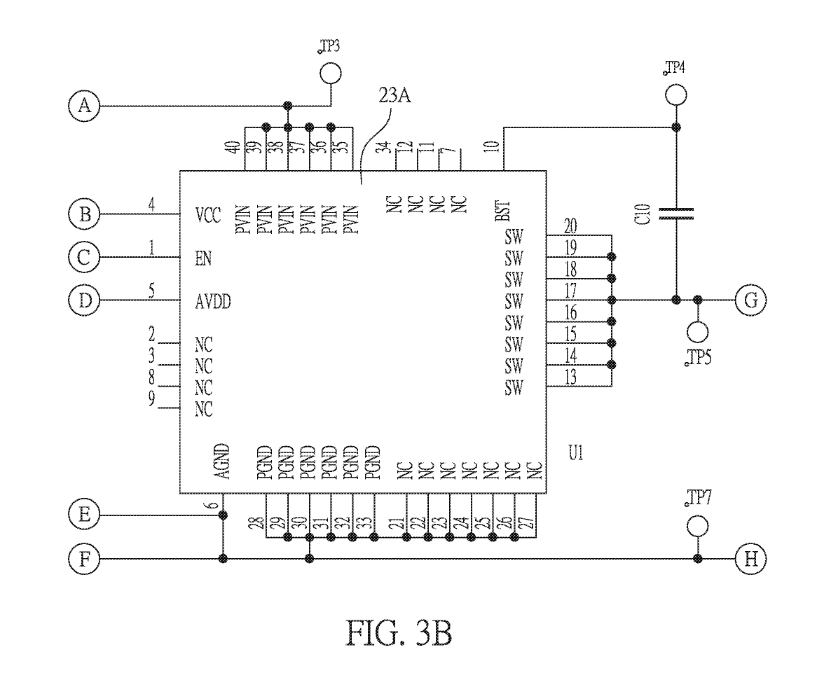

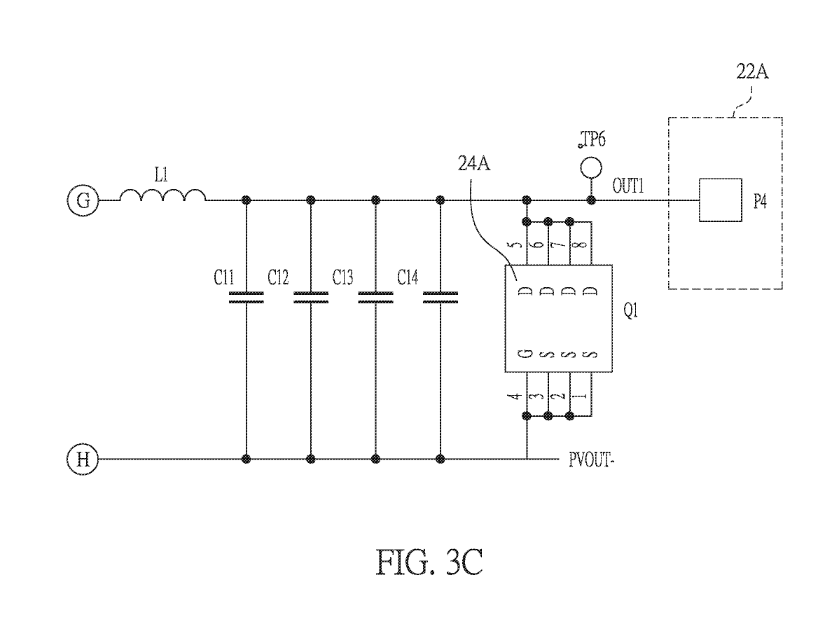

The power optimization module blocks 10A, 10B, 10C have an identical circuit layout. With reference to FIGS. 3A to 3C, the power optimization module block 10A includes a string connection port 21A, a power output port 22A and a single-chip processor 23A. In the present embodiment, the power optimization module block 10A further includes a bypass switch 24A.

The string connection port 21A is connected to the positive terminal PV1+ and the negative terminal PV1− of the power output terminal 101 of the string of photovoltaic modules PV1. In other words, the string connection port 21A is treated as a power input terminal to receive power transmitted from the string of photovoltaic modules PV1.

The power output port 22A includes a positive output terminal OUT1 and a negative output terminal PVOUT− for connection with other power optimization module block. In the present embodiment, the positive output terminal OUT1 is connected in series to the power output port of the power optimization module block 10B adjacent thereto, and the negative output terminal PVOUT− is taken as a negative power terminal of the solar panel 100. The bypass switch 24A is connected between the positive output terminal OUT1 and the negative output terminal PVOUT− for isolating the connected string of photovoltaic modules PV1 from the serial loop when the string of photovoltaic modules PV1 encounters a fault.

The single-chip processor 23A is connected to the string connection port 21A and the power output port 22A and performs MPPT pertinent to the connected string of photovoltaic modules PV1.

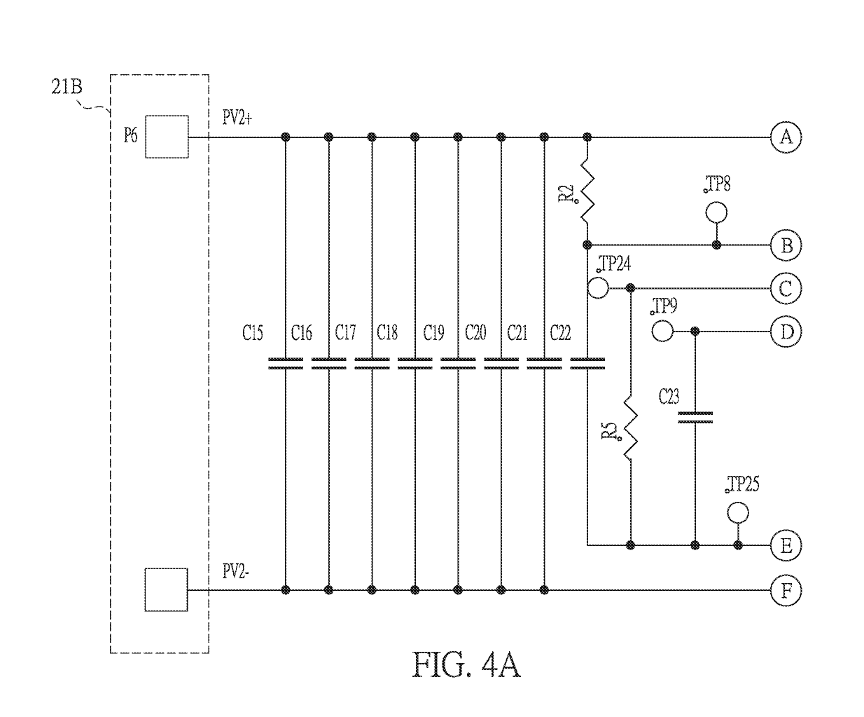

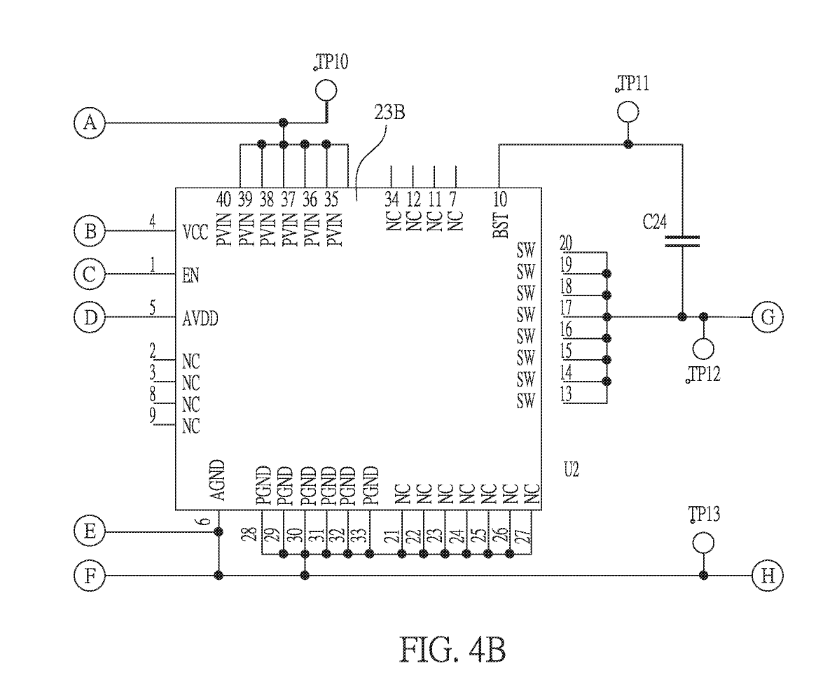

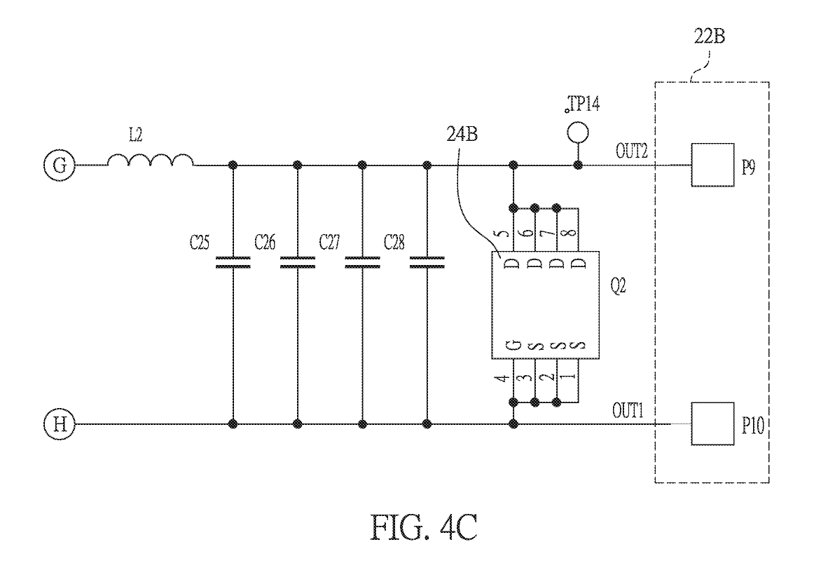

With reference to FIGS. 4A to 4C, the power optimization module block 10B is of a circuit layout identical to that of the power optimization module block 10A and includes a string connection port 21B, a power output port 22B, a single-chip processor 23B and a bypass switch 24B.

The string connection port 21B is connected to the positive terminal PV2+ and the negative terminal PV2− of the power output terminal 102 of the string of photovoltaic modules PV2. The power output port 22B includes a positive output terminal OUT2 and a negative output terminal OUT1. In the present embodiment, the positive output terminal OUT2 is connected in series to the power output port of the power optimization module block 10C adjacent thereto, and the negative output terminal OUT1 is connected in series to the positive output terminal OUT1 of the string connection port 21A of the power optimization module block 10A.

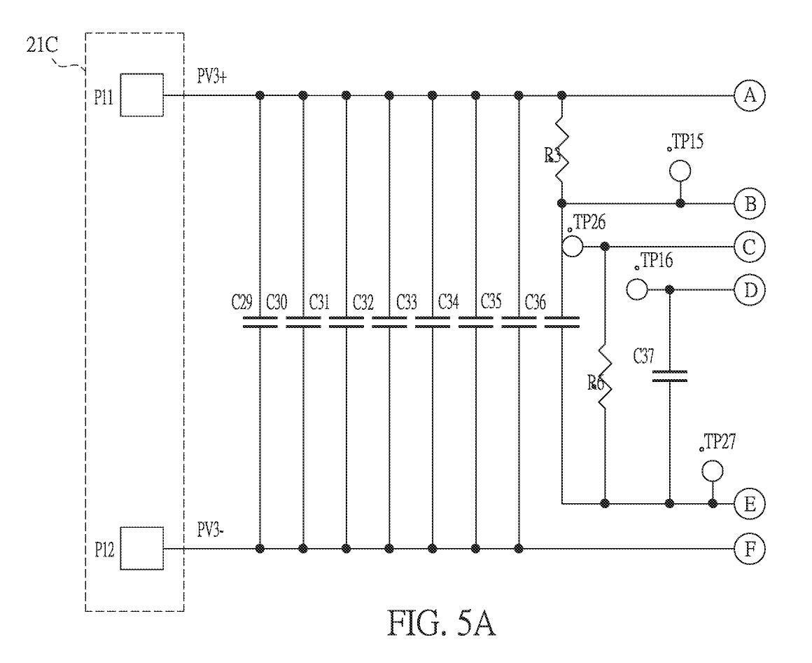

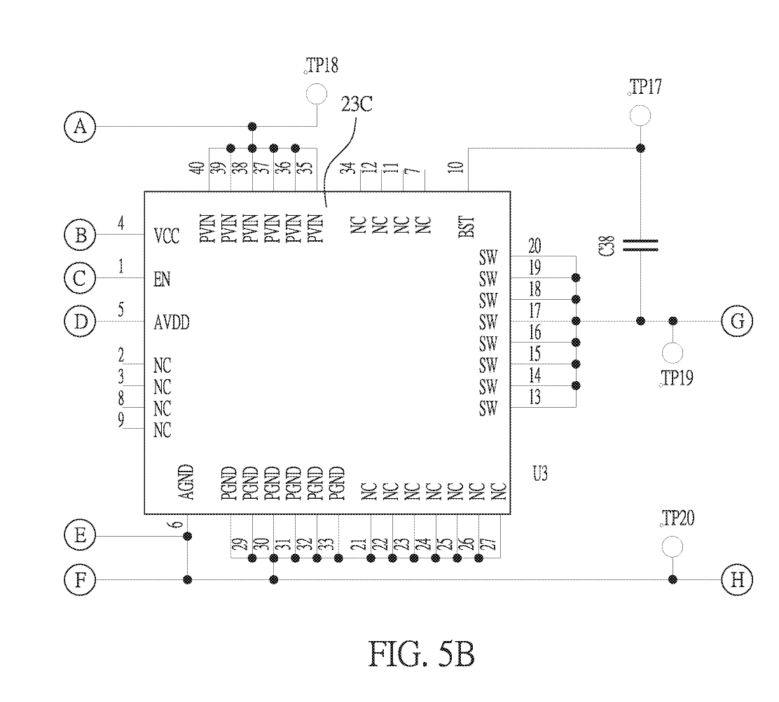

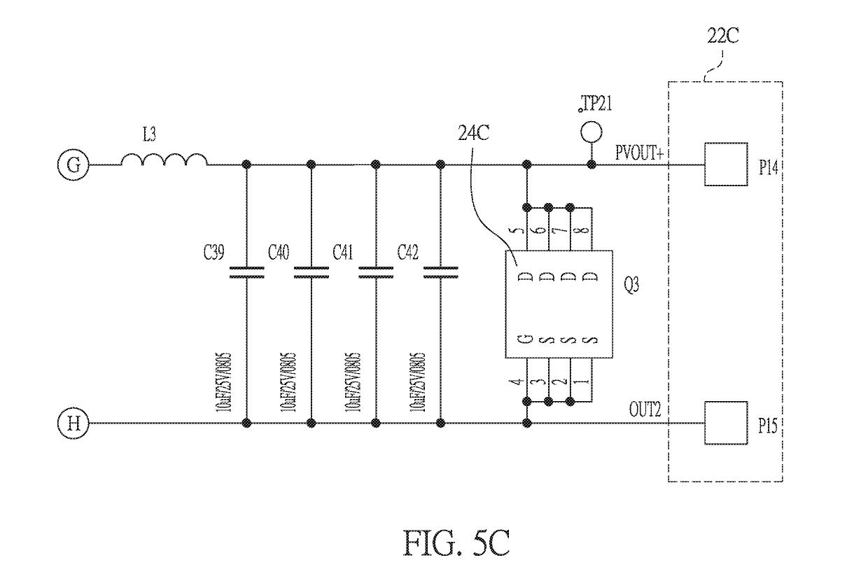

With reference to FIGS. 5A to 5C, the power optimization module block 10C is of a circuit layout identical to those of the power optimization module blocks 10A, 10B and includes a string connection port 21C, a power output port 22C, a single-chip processor 23C and a bypass switch 24C.

The string connection port 21C is connected to the positive terminal PV3+ and the negative terminal PV3− of the power output terminal 103 of the string of photovoltaic modules PV3. The power output port 22C includes a positive output terminal PVOUT+ and a negative output terminal OUT2. In the present embodiment, the negative output terminal OUT2 is connected in series to the positive output terminal OUT2 of the string connection port 21B of the power optimization module block 10B adjacent thereto, and the positive output terminal PVOUT+ is taken as a positive power terminal of the solar panel 100. The solar panel 100 may be connected to other solar panels by using the positive power terminal and the negative power terminal thereof.

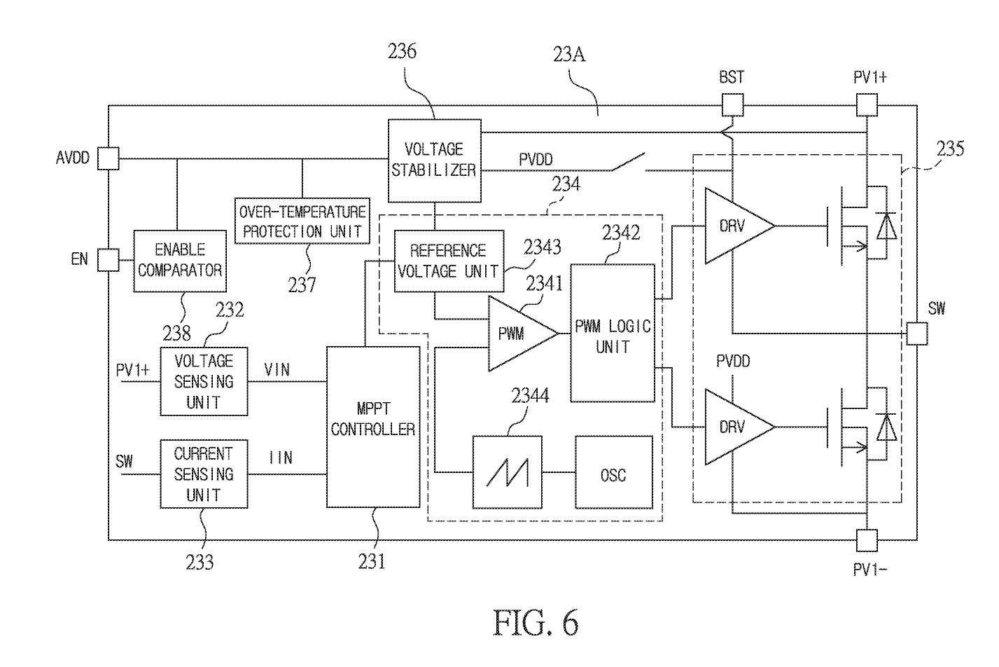

With reference to FIG. 6, the single-chip processor of each power optimization module block 10A, 10B, 10C, given the power optimization module block 10A as an example, includes an MPPT controller 231, a voltage sensing unit 232, a current sensing unit 233, a pulse width modulation (PWM) circuit 234, a buck converter 235 and a voltage stabilizer 236.

The MPPT controller 231 is connected to the voltage sensing unit 232 and the current sensing unit 233. An input terminal of the voltage sensing unit 232 is connected to the positive terminal PV1+ of the power output terminal 101 of the string of photovoltaic modules PV1 to detect an output voltage of the string of photovoltaic modules PV1. The current sensing unit 233 is connected to an output terminal SW of the buck converter 235 to acquire an average output current of the string of photovoltaic modules PV1. The MPPT controller 231 computes according to the output voltage and the average output current of the string of photovoltaic modules PV1 and adjusts a control signal to the buck converter 235 using the PWM circuit 234 to perform computation of MPPT on the string of photovoltaic modules PV1.

The voltage stabilizer 236 is connected to the positive terminal PV1+ of the string of photovoltaic modules PV1 through the string connection port 21A to acquire power outputted from the string of photovoltaic modules PV1 and convert the power into a stable DC (Direct Current) power as an operating power to the single-chip processor 23A.

The PWM circuit 234 includes a comparator 2341, a PWM logic unit 2342, a reference voltage unit 2343, a ramp generator 2344 and an oscillator OSC. The reference voltage unit 2343 generates a reference voltage value according to a computation result for MPPT from the MPPT controller 231. The comparator 2341 compares a signal generated by the ramp generator 2344 with the reference voltage value to generate a comparison result. The PWM logic unit 2342 adjusts a control signal to the buck converter 235 according to the comparison result.

In the present embodiment, the single-chip processor 23A further includes an over-temperature protection unit 237 and an enable comparator 238. The over-temperature protection unit 237 has a temperature-sensing function. When a temperature of the single-chip processor 23A detected by the over-temperature protection unit 237 exceeds a configured value, the over-temperature protection unit 237 switches off the buck converter 235 for the single-chip processor 23A to enter a protection state.

The enable comparator 238 has two input terminals and an output terminal. The two input terminals of the enable comparator 238 are respectively connected to an enable (EN) pin and an internal voltage AVDD (5V) of the single-chip processor 23A. The EN pin is used to connect with an external circuit outside the single-chip processor 23A for the external circuit to change a voltage level of the EN pin. The output terminal of the enable comparator 238 is connected to the buck converter 235.

The enable comparator 238 compares the voltage level of the EN pin with the internal voltage AVDD of the single-chip processor 23A. In the case of a normal condition, the EN pin stays at a high voltage level and the enable comparator 238 is disabled. When the voltage level of the EN pin is drawn by the external circuit to a low voltage level, the enable comparator 238 switches off the buck converter 235 and bypasses the corresponding string of photovoltaic modules PV1 through the bypass switch 24A to ensure other strings of photovoltaic modules PV2, PV3 of the solar panel 100 to operate normally.

From the foregoing description, the split-type power optimization module for solar module strings of a solar panel can prevent over-temperature, over-voltage, under-voltage, and over-current conditions and protect each string of photovoltaic modules by means of bypassing the faulty string of photovoltaic modules, thereby reducing the performance downgrade during the life cycle of the solar panel. Besides, the approach of concentrating circuits of most of the core elements for performing string-level power optimization in each power optimization module block in the single-chip processor allows the power optimization module blocks to have an integrated structure with enhanced overall performance.

The split-type power optimization module includes three power optimization module blocks connected to the respective strings of photovoltaic modules on the solar panel. As each power optimization module block performs power optimization on a corresponding string of photovoltaic modules, when the multiple strings of photovoltaic modules on the solar panel are subject to different radiations as shaded by buildings, trees and the like, the power optimization module blocks can perform the MPPT processing based on different conditions of solar radiation to achieve maximum power optimization and optimized efficacy of the solar panel.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A split-type power optimization module for solar module strings of a solar panel, wherein the power optimization module includes multiple power optimization module blocks and the solar panel includes multiple solar module strings, each power optimization module block comprising:
a string connection port connected to a power output terminal of a corresponding solar module string of the solar panel;
a power output port having a positive output terminal and a negative output terminal and connected in series to the power output port of another power optimization module block adjacent to the corresponding power optimization module block;
a single-chip processor connected to the string connection port and the power output port and performing maximum power point tracking (MPPT) on the corresponding solar module string; and
a bypass switch connected between the positive output terminal and the negative output terminal of the power output port.

2. The split-type power optimization module as claimed in claim 1, wherein the single-chip processor includes:
an MPPT controller;
a voltage sensing unit connected to the MPPT controller and having an input terminal connected to the positive output terminal of the corresponding solar module string to detect an output voltage of the corresponding solar module string;
a buck converter having an output terminal;
a current sensing unit connected to the MPPT controller and connected to the output terminal of the buck converter to acquire an average output current of the corresponding solar module string;
a pulse width modulation (PWM) circuit; and
a voltage stabilizer;
wherein the MPPT controller performs MPPT on the corresponding solar module string according to the output voltage and the average output current of the corresponding solar module string and adjusts a control signal to the buck converter using the PWM circuit.

3. The split-type power optimization module as claimed in claim 2, wherein the PWM circuit includes:
a reference voltage unit generating a reference voltage value according to a computation result for MPPT from the MPPT controller;
a ramp generator;
a comparator comparing a signal generated by the ramp generator with the reference voltage value to generate a comparison result;
a PWM logic unit adjusting the control signal to the buck converter according to the comparison result; and
an oscillator.

4. The split-type power optimization module as claimed in claim 2, wherein the single-chip processor further includes an over-temperature protection unit detecting a temperature of the single-chip processor, and when the detected temperature exceeds a configured value, the over-temperature protection unit switches off the buck converter for the single-chip processor to enter a protection state.

5. The split-type power optimization module as claimed in claim 2, wherein the single-chip processor further includes an enable comparator having:
two input terminals respectively connected to an enable pin and an internal voltage of the single-chip processor; and
an output terminal connected to the buck converter.

6. The split-type power optimization module as claimed in claim 2, wherein the voltage stabilizer is connected to the power output terminal of the corresponding solar module string through the string connection port to acquire power outputted from the corresponding solar module string and convert the power into a stable DC (Direct Current) operating power.

7. The split-type power optimization module as claimed in claim 1, wherein a count of the multiple power optimization module blocks corresponds to a count of the multiple solar module strings of the solar panel.

8. The split-type power optimization module as claimed in claim 2, wherein a count of the multiple power optimization module blocks corresponds to a count of the multiple solar module strings of the solar panel.

9. The split-type power optimization module as claimed in claim 3, wherein a count of the multiple power optimization module blocks corresponds to a count of the multiple solar module strings of the solar panel.

10. The split-type power optimization module as claimed in claim 4, wherein a count of the multiple power optimization module blocks corresponds to a count of the multiple solar module strings of the solar panel.

11. The split-type power optimization module as claimed in claim 5, wherein a count of the multiple power optimization module blocks corresponds to a count of the multiple solar module strings of the solar panel.

12. The split-type power optimization module as claimed in claim 6, wherein a count of the multiple power optimization module blocks corresponds to a count of the multiple solar module strings of the solar panel.

13. The split-type power optimization module as claimed in claim 7, comprising three power optimization module blocks, wherein the solar panel includes three solar module strings corresponding to the respective three power optimization module blocks.

14. The split-type power optimization module as claimed in claim 8, comprising three power optimization module blocks, wherein the solar panel includes three solar module strings corresponding to the respective three power optimization module blocks.

15. The split-type power optimization module as claimed in claim 9, comprising three power optimization module blocks, wherein the solar panel includes three solar module strings corresponding to the respective three power optimization module blocks.

16. The split-type power optimization module as claimed in claim 10, comprising three power optimization module blocks, wherein the solar panel includes three solar module strings corresponding to the respective three power optimization module blocks.

17. The split-type power optimization module as claimed in claim 11, comprising three power optimization module blocks, wherein the solar panel includes three solar module strings corresponding to the respective three power optimization module blocks.

18. The split-type power optimization module as claimed in claim 12, comprising three power optimization module blocks, wherein the solar panel includes three solar module strings corresponding to the respective three power optimization module blocks.
